(19) United States
(12) Patent Application Publication
(10) Pub. No.: US 2002/0069202 A1
(43) Pub. Date: Jun. 6, 2002

(54) Medical emergency response database system

(76) Inventors: Rodney James Elwin Deans, Edmonton (CA); Lloyd Richard Osler, Edmonton (CA)

Correspondence Address: DAVIS & BUJOLD, P.L.L.C., 500 NORTH COMMERCIAL STREET, FOURTH FLOOR, MANCHESTER, NH, 03101, US

(21) Appl. No.: 09/878,489

(22) Filed: Jun. 11, 2001

(30) Foreign Application Priority Data
Dec. 5, 2000 (CA) 2, 327, 571

(51) Int. Cl. G06F 7/00

(52) U.S. Cl. 707/10

(57) ABSTRACT

An emergency medical response database system includes a database containing a plurality of data fields. A data entry interface is provided for entering data into the data fields. The data entry interface permits medical data to be entered into the data fields in substantially any order desired by individual medical personnel. A data field selection filter is disposed between the database and the data entry interface. This permits user organizations to select the data fields from the database which appear on the data entry interface for data entry by individual medical personnel.

### FIELD OF THE INVENTION

The present invention relates to a medical emergency response database system

### BACKGROUND OF THE INVENTION

Medical emergency response database systems facilitate record keeping by ambulance companies, fire departments, hospitals and health authorities. A variety of information must be recorded. Government regulatory authorities in each jurisdiction require certain minimum information to be kept, so, when auditing, they can ensure compliance with the laws of the jurisdiction. The information the government requires is frequently referred to as the “minimum data set”. Over and above the minium data set, each user organization has further information which is it also wants to be recorded for such purposes as: facilitating on going medical treatment, protecting the organization from liability claims, evaluating performance of the medical emergency response teams and individual medical personnel, and facilitating patient or health insurance billing. In addition, there are pubic interest programs conducted by emergency medical response organizations from time to time, such as tracking the number and nature of skate board injuries.

The approach that has been taken by computer programmers is to consult with health care professionals regarding emergency services protocol and the information to be recorded. The resulting medical emergency response database systems contain all of the information to be recorded with a sequential entry process that closely follows the emergency services protocol, as related to the programmers.

A disadvantage inherent in the prior art approach is that, in order to use the emergency medical response database system, a user organization must alter their emergency services protocol to follow the sequential entry process; as considerable reprogramming is required to change the sequence of the entry process. The user organization is, similarly, limited to collecting the information contemplated at the time of programming, as considerable reprogramming is required to work new data fields into the sequential data entry process.

It is being discovered that emergency medical response database systems which are in full compliance with the laws of the State of New York, are not necessarily in compliance with the laws of the State of California. Similarly, emergency medical response database systems that meet ambulance companies protocols, do not necessarily meet fire department protocols. Even within the same State and the same category of emergency medical response organization, protocols vary widely.

U.S. Pat. No. 6,117,073 (Jones et al) which issued Sep. 12, 2000 is an example of one of the state of the art emergency medical response database systems. The Jones et al database system contains all the information believed to be necessary at the time of programming and follows the best sequential order of entry protocol known at the time of programming. The problem with database systems, such as Jones et al, is that they are unable to adapt to the diverse and changing needs of emergency medical response organizations.

### SUMMARY OF THE INVENTION

What is required is an emergency medical response database system that has greater flexibility.

According to the present invention there is provided an emergency medical response database system which includes at least one database containing a plurality of data fields A data entry interface is provided for entering data into the data fields. The data entry interface permits medical data to be entered into the data fields in substantially any order desired by individual medical personnel. A data field selection filter is disposed between the at least one database and the data entry interface. This permits user organizations to select the data fields from the database which appear on the data entry interface for data entry by medical personnel.

The emergency medical response database system, as described above, enables the user organization to select from a huge number of data fields the data fields that the user organization desires to include as part of this record keeping. This enables the emergency medical response database system to be readily “tailored” to meet the needs of the user organization.

The emergency medical response database system, as described above, does not links the entry of data into the database with any sequential emergency services protocol. This enables individual medical personnel to enter data in accordance with the emergency medical protocol of their user organizations with additional flexibility being provided to accommodate the nature of the medical emergency and individual entry preferences. For example, with a cardiac arrest the emergency medical protocol for the user organization may require a chronological entry sequence. In contrast, for a simple call, such as a fall on an icy sidewalk; their may not exist an emergency response protocol and the chronological order of events may be irrelevant. In these circumstances, medical personnel may be wish to quickly jump to outcome. In some cases, the emergency medical protocol may change part way through. For example, when an emergency response team dispatched to the scene of what is supposed to be a simple fall on an icy sidewalk must deal with a medical emergency when it is discovered that the person who fell has suffered a heart attack.

Although beneficial results may be obtained through the use of the medical emergency response database system, as described above, each user organization will want the flexibility to add new fields to the database. The tracking of skate board accidents provided for in the original database may have to be supplemented with tracking for roller blade injuries or scooter injuries in order to keep up with societal changes.

Although beneficial results may be obtained through the use of the medical emergency response database system, as described above, problems exist with respect to the use of differing terminology between user organizations. For example, some user organizations identify the severity of the medical emergency as Code 1, Code 2 or Code 3; other user organizations identify the severity of the medical emergency as Alpha, Bravo or Charlie. Even more beneficial results may, therefore, be obtained when the database contains aliases for data fields to accommodate differences in terminology between user organizations. This enables the identical data fields to appear as Code 1, Code 2, Code 3 or as Alpha, Bravo, Charlie, depending upon the preferences of the user organization.

Although beneficial results may be obtained through the use of the emergency medical response database system, as described above, even more beneficial results may be obtained when a substantial portion of the data entry interface for medical data consists of pick lists from which a selection is made. This provides two advantages. It speeds up data entry by minimizing typed input. It also standardizes data entry, which facilitates subsequent review and analysis of the data.

Although beneficial results may be obtained through the use of the emergency medical response database system, as described above, many networks systems require a continuous connection with a server for the user organization in order to remain effective. The reality is that it is not always possible to maintain a continuous connection. Connections are frequently intermittent, especially in remote areas. Even more beneficial results may, therefore, be obtained when a plurality of computers, each operated by individual medical personnel, are linked to a user organization server through a pervasive virtual private network on the world wide web in which each of the plurality of computers has the database and means is provided for syncronization of the database on the user organization server and the plurality of computers. Pervasive virtual private networks can continue functioning with intermittent connection as they store data and then forward that data to the user organization server upon the network connection being restored.

Although beneficial results may be obtained through the use of the emergency medical response database system, as described above, it is desirable that every user organization be able to gauge their performance as compared to the performance of other user organizations. Even more beneficial results may, therefore, be obtained when each user organization server is linked to a supervisory organization computer through the world wide web. This enables data to be down loaded from user organization servers of each of a plurality of user organizations and statistically analyzed to determine tendencies, averages and performance as compared to the plurality of user organizations.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a block diagram relating to elements within a emergency medical response database system configured in accordance with the teachings of the present invention.

FIG. 2 is a block diagram relating to elements within a network configuration of the emergency medical response database system illustrated in FIG. 1.

### DETAILED DESCRIPTION OF THE PREFERRED EMBODIMENT

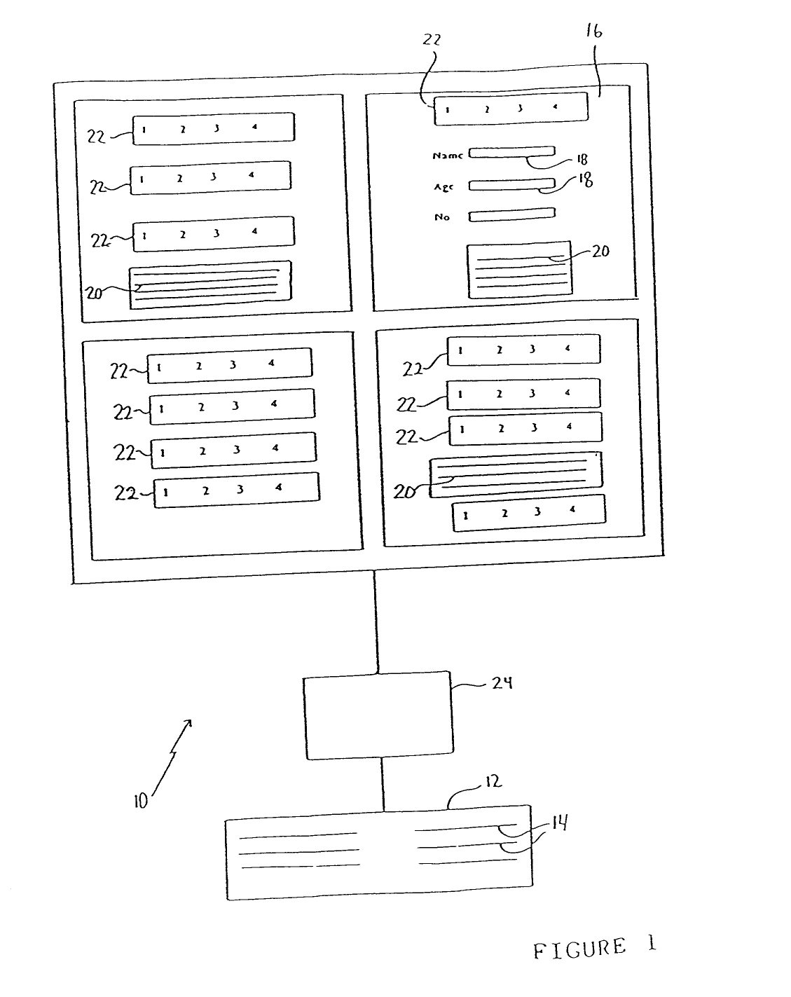

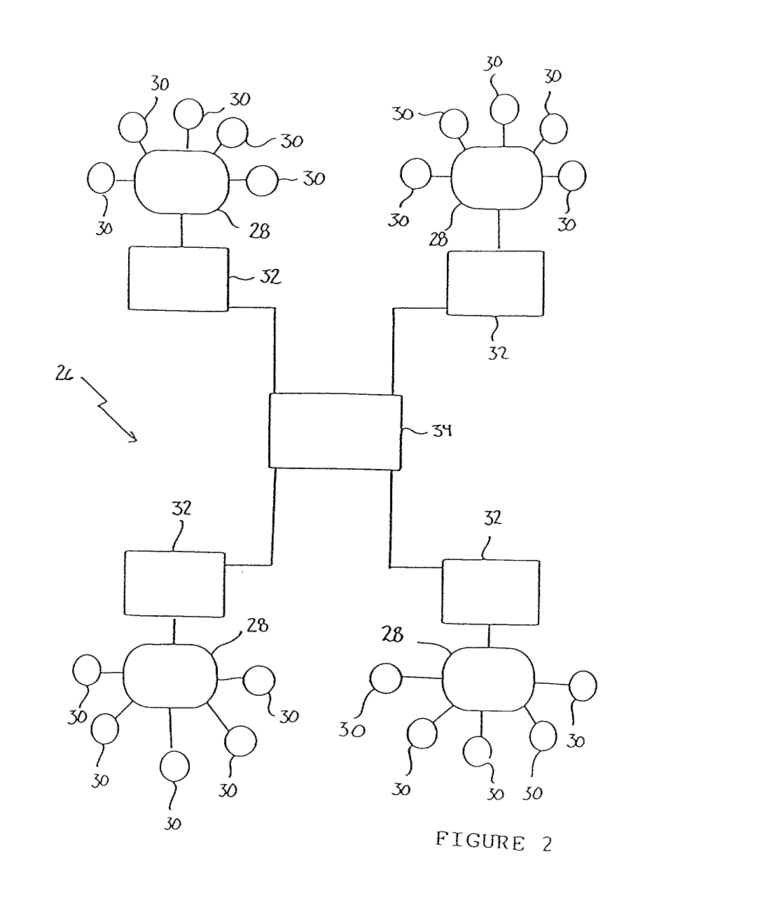

The preferred embodiment, an emergency medical response database system generally identified by reference numeral 10, will now be described with reference to FIGS. 1 and 2.

Structure and Relationship of Parts:

Referring to FIG. 1, emergency medical response database system 10 includes a database 12. Database 12 contains a plurality of data fields 14. It is preferred that database 12 be capable of being expanded by the addition of additional data fields, as required. This has been successfully done by making database 12 a collection of smaller databases. A data entry interface 16 is provided for entering data into data fields 14 of database 12. Data entry interface 16 is not tied to any particular sequential medical emergency response protocol. Data entry interface 16 permits medical data to be entered into data fields 14 in substantially any order desired by individual medical personnel. There are a number of patient information data fields 18 forming part of data entry interface 16 that must be manually completed. There are also a number of commentary data fields 20 forming part of data entry interface 16. Commentary data fields 20 permit specific observations and comments about the medical emergency to be made by individual medical personnel. Most, if not all, of the remaining data fields forming a substantial portion of data entry interface 16 are pick lists 22 from which a selection is made. A data field selection filter 24 is disposed between database 12 and data entry interface 16 Data field selection filter 24 permits user organizations to select which data fields 14 from database 12 will be appear on data entry interface 16 for data entry by individual medical personnel.

Referring to FIG. 2, there is illustrated how a number of user organizations would be connected over the world wide web to a supervisory network, generally indicated by reference numeral 26. Supervisory network 26 is made up of a number of satellite networks, generally indicated by reference numeral 28. Each satellite network 28 has a plurality of computers 30 linked to a user organization server 32 through a pervasive virtual private network on the world wide web in which each of plurality of computers 30 has database 12 (or at least those portions of database 12 that field personnel require access to) and means is provided for syncronization of data in database 12 on user organization server 32 with database 12 in plurality of computers 30 every time a connection is made. The satellite networks 28 are, in turn, linked to supervisory network 26 with each user organization server 32 being linked to a supervisory organization server 34.

Operation:

The use and operation of emergency medical response database system 10 will now be described with reference to FIGS. 1 and 2. Referring to FIG. 1, when a user organization decides to use emergency medical response database system 10, a selection is made by the user organization as to which of data fields 14 from database 12 are to appear in data entry interface 16. The data fields selected include the minimum data set of the jurisdiction, along with such additional data fields as are necessary to maintain all the user organizations medical, emergency response evaluation, personnel and financial records. The terminology visible to individual medical personnel on data entry interface 16 is altered, where required, with the alias features in database 12 so the terminology is consistent with the standard set by the user organization.

Referring to FIG. 2, each emergency medical response team is equipped with computer 30 which is linked to user organization server 32 through a pervasive virtual private network on the world wide web as part of the user organizations satellite network 28. This type of network is preferred due to the fact that it can continue to function even when the connection is intermittent. Data is exchanged and updated with user organization server 32 at periodic intervals or every time an intermittent connection is made.

Referring to FIG. 1, individual medical personnel from the emergency medical response team, typically, perform entry through database entry interface 16 after an emergency medical call has been dealt with. Where possible, patient information data fields 18 are completed in advance by a dispatcher. Most of the data entry is entered through pick lists 22, supplemented when and as required by comments in commentary data fields 20. A major advantage of emergency medical response database system 10 is that in making their data entry individual medical personnel can follow whatever emergency response protocol has been adopted by the user organization. Data entry interface 16 will accept input in any order. The sequential entry structure of prior art emergency medical response database systems was beneficial when training new medical personnel in emergency medical protocol, but slowed down experienced medical personnel. For example, data entry of a cardiac arrest incident in prior art systems typically takes 45 minutes for experienced medical personnel In prototype testing of emergency medical response database system 10, entry by experienced medical personnel was reduced to 15 minutes.

Although data entry interface 16 is non-structured in terms of order of entry, database 12 at all times maintains an underlying structure so that whatever reports may be required can be drawn from data fields 14 by the user organization. The use of pick lists 22 serves an important role in standardizing data. The data in those data fields provided from pick lists 22 can then be down loaded from user organization server 32 of user organization satellite network 28 to supervisory organization server 34 of supervisory network 26. It is to be noted that none of the data from patient information data fields 18 or commentary data fields 20 is down loaded. The data in those data fields provided from pick lists 22 provides standardized data that can be analyzed and compared against like data from other user organizations. This enables user organizations to gauge how they are performing, as compared to other user organizations.

As described above, beneficial results have been obtained in providing additional flexibility when database 12 is composed of a collection of smaller databases. This configuration has provided maximum flexibility. For example, an inventory control feature can reside in one database. With some user organizations this feature will not be emphasized and a only a limited number of data fields may be used with the remainder being excluded through the mechanism of data field selection filter 24. However, when this feature is desired the inventory control database will receive information of a medical procedure being performed, such as an intravenous drip (IV). The inventory control database will then calculate that if an IV was performed one needle, a length of tubing and certain miscellaneous supplies will be required to replenish the emergency vehicle. The concept of a collection of databases enables additional functionality to be added to the system merely be adding a further database in which the knowledge to operate the added function resides.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the claims.

The embodiments of the invention in which an exclusive property or privilege is claimed are defined as follows:

1. An emergency medical response database system, comprising:
at least one database containing a plurality of data fields;
a data entry interface for entering data into the data fields of the at least one database, the data entry interface permitting medical data to be entered into the data fields in substantially any order desired by individual medical personnel; and
a data field selection filter disposed between the at least one database and the data entry interface, whereby user organizations select what data fields from the at least one database will be appear on the data entry interface for data entry by individual medical personnel.

2. The emergency medical response database system as defined in claim 1, wherein the at least one database has the capability of being expanded by the addition of additional data fields, as required by a user organization.

3. The emergency medical response database system as defined in claim 1, wherein there are several databases.

4. The emergency medical response database system as defined in claim 1, wherein the at least one database contains aliases for data fields to accommodate differences in terminology between user organizations.

5. The emergency medical response database system as defined in claim 1, wherein a substantial portion of the data entry interface for medical data consists of pick lists from which a selection is made, thereby both speeding up and standardizing data entry.

6. The emergency medical response database system as defined in claim 1, wherein a plurality of computers, each operated by individual medical personnel, are linked to a user organization server through a pervasive virtual private network on the world wide web in which each of the plurality of computers has the at least one database and means is provided for syncronization of the at least one databases on the user organization server and the plurality of computers.

7. The emergency medical response database system as defined in claim 6, wherein each user organization server is linked to a supervisory organization computer through the world wide web, whereby data is down loaded from user organization servers of each of a plurality of user organizations and statistically analyzed to determine tendencies and averages in the plurality of user organizations.

8. An emergency medical response database system, comprising:
a database containing a plurality of data fields, the database having the capability of being expanded by the addition of additional data fields;
a data entry interface for entering data into the data fields, the data entry interface permitting medical data to be entered into the data fields in substantially any order desired by individual medical personnel, a substantial portion of the data entry interface for medical data being pick lists from which a selection is made, thereby both speeding up and standardizing data entry; and
a data field selection filter disposed between the database and the data entry interface, whereby user organizations select what data fields from the database will be appear on the data entry interface for data entry by individual medical personnel.

9. The emergency medical response database system as defined in claim 8, wherein the database contains aliases for data fields to accommodate differences in terminology between user organizations.

10. The emergency medical response database system as defined in claim 8, wherein a plurality of computers, each operated by individual medical personnel, are linked to a user organization server through a pervasive virtual private network on the world wide web in which each of the plurality of computers has the database and means is provided for syncronization of the database on the user organization server and the plurality of computers.

11. The emergency medical response database system as defined in claim 10, wherein each user organization server is linked to a supervisory organization computer through the world wide web, whereby data is down loaded from user organization servers of each of a plurality of user organizations and statistically of user organizations.

12. An emergency medical response database system, comprising:
a collection of databases containing a plurality of data fields, the collection of databases having the capability of being expanded by the addition of additional databases;
a data entry interface for entering data into the data fields through a plurality of computers linked to a user organization server through a pervasive virtual private network on the world wide web in which each of the plurality of computers has at least some of the collection of databases and means is provided for syncronization of the collection of databases on the user organization server and the plurality of computers, the data entry interface permitting medical data to be entered into the data fields in substantially any order desired by individual medical personnel, a substantial portion of the data entry interface for medical data being pick lists from which a selection is made, thereby both speeding up and standardizing data entry;
a data field selection filter disposed between the database and the data entry interface, whereby user organizations select what data fields from the collection of databases will be appear on the data entry interface for data entry by individual medical personnel; and
the user organization server being linked to a supervisory organization computer through the world wide web, whereby data is down loaded from the user organization server of the user organization and statistically compared with data from other user organizations.
